(19) United States
(12) Patent Application Publication
(10) Pub. No.: US 2016/0116942 A1
(43) Pub. Date: Apr. 28, 2016

(54) DOCKING STATION AND ELECTRONIC ASSEMBLY

(71) Applicant: Acer Incorporated, New Taipei City (TW)

(72) Inventors: Jian-Siang Wang, New Taipei City (TW); Yung-Chih Wang, New Taipei City (TW)

(21) Appl. No.: 14/595,216

(22) Filed: Jan. 13, 2015

(30) Foreign Application Priority Data
Oct. 22, 2014 (TW) 103136435

(51) Int. Cl. G06F 1/16; G06F 1/20

(52) U.S. Cl. CPC G06F 1/1632; G06F 1/203; G06F 1/1669

(57) ABSTRACT

A docking station for a portable electronic device is provided. The docking station includes a body, a supporting base and at least one hook. The body has a chamber and at least one air flow opening communicated with the chamber. The supporting base is pivoted to the body and has at least one air flow channel. The at least one hook protrudes from the supporting base and has at least one communicating hole. The at least one air flow channel communicates the at least one communicating hole and the chamber. An electronic assembly using the docking station is also provided.

### CROSS-REFERENCE TO RELATED APPLICATION

This application claims the priority benefit of Taiwan application serial no. 103136435, filed on Oct. 22, 2014. The entirety of the above-mentioned patent application is hereby incorporated by reference herein and made a part of this specification.

### BACKGROUND OF THE INVENTION

1. Field of the Invention

The invention relates to a docking station and an electronic assembly, and particularly relates to a docking station and an electronic assembly using a docking station.

2. Description of Related Art

In an era of ever evolving technology, it has been accompanied by many portable electronic devices such as notebook computers, smart phones and tablet PCs and the like. These portable electronic devices naturally found its way into becoming an essential part in the daily life of man. Taking the tablet PC for example, the light weight and easy to carry features make it relatively convenient for a user to use when going outdoors.

Generally speaking, cooling methods of tablet PCs may be divided into two types. Fan type cooling and fanless type cooling, wherein the fan type cooling results in consumption of internal space in the tablet PC, and may not be advantageous for thin design requirements. In addition, the noise produced by the operation of a fan, will also make the user feel uncomfortable. Due to this, a large number of commonly seen tablet PCs adopt a fanless type cooling method, for example through a film or sheet composed of copper foil or other material having high thermal conductivity attached to the heated element, in order to transfer the heat produced by the heated element to the film or sheet composed of copper foil or other material having high thermal conductivity, and then transferring from the film or sheet composed of copper foil or other material having high thermal conductivity to the back cover of the tablet PC, and then further effusing to the surrounding. However, during high performance operations, the electronic components in a tablet PC produce a large amount of heat, where the fanless type cooling method to cool the heated element is difficult to effuse the above mentioned large amounts of heat quickly, having a limited cooling effect.

### SUMMARY OF THE INVENTION

The invention provides a docking station may improve the cooling efficiency of the portable electronic device assembled to the docking station.

The invention provides an electronic assembly having improved cooling efficiency.

The invention provides a docking station, suitable for a portable electronic device. The docking station includes a body, a supporting base and at least one hook. The body has a chamber and at least one air flow opening communicating with the chamber. The supporting base is pivoted to the body, and has at least one air flow channel. The at least one hooks protrude from the supporting base, and has at least one communicating hole. The at least one air flow channel communicates the at least one communicating hole and the chamber.

The invention provides an electronic assembly including a docking station and a portable electronic device. The docking station includes a body, a supporting base and at least one hook. The body has a first chamber and at least one first air flow openings communicating with the chamber. The supporting base is pivoted to the body, and has at least one air flow channel. The at least one hook protrudes from the supporting base, and has at least one communicating hole. The at least one air flow channel communicates the at least one communicating hole and the first chamber. A portable electronic device is detachably assembled to the docking station. The portable electronic device includes a machine body and a casing. The casing is engaged to the machine body, and defining a second chamber, wherein the casing has at least one slot, at least one opening located in the at least one slot and at least one second air flow opening. The second chamber respectively communicates the at least one second air flow opening and the at least one opening. When the portable electronic device is assembled to the docking station and has the at least one hook inserted into the at least one slot, the second chamber communicates to the first chamber through the at least one opening, the at least one communicating hole and the at least one air flow channel.

Based on the above, the hook of the docking station of the invention has the communicating hole communicating to the first chamber of the body through the air flow channel of the supporting base, and the first chamber communicates to the surrounding through the first air flow opening. On the other hand, the second chamber is defined by the machine body and the casing engaged with each other of the portable electronic device, wherein the casing has the opening and the second air flow opening communicating with the second chamber, and the opening is located in the slot. Therefore, the hook will be inserted into the slot after the portable electronic device is assembled to the docking station to make up the electronic assembly. Here, the first chamber may communicate with the second chamber through the air flow channel, the communicating hole and the opening.

During the operation of the portable electronic device, the heat produced by the internal components will increase the air temperature in the second chamber. Then the heated air in the second chamber may flow into the first chamber through the opening, the communicating hole and the air flow channel, and then emitted to the surrounding from the first air flow opening. And at the same time, cool air of the surrounding will flow into the second chamber from the second air flow opening, and execute heat exchange with the internal components, and similarly, after the above cool air executes heat exchange with the internal components and turns into heated air, the above heated air flows to the first chamber through the opening, the communicating hole and the air flow channel, and is then emitted to the surrounding from the first air flow opening. Therefore, the heat produced by the internal components may be quickly effused to the surrounding effectively by the above air circulation model, further increasing the working efficiency of the portable electronic device, and extending the operating life.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a docking station according to an embodiment of the invention.

FIG. 2A is a partially enlarged schematic view illustrating a supporting base and a hook of FIG. 1.

FIG. 2B and FIG. 2C is a partially enlarged schematic view illustrating a supporting base and a hook according to another embodiment of the invention.

FIG. 3 is a schematic view illustrating a docking station according to another embodiment of the invention.

FIG. 4 is a schematic plan view illustrating an electronic assembly according to an embodiment of the invention.

FIG. 5 is a schematic plan view illustrating an electronic assembly according to another embodiment of the invention.

FIG. 6 is a schematic plan view illustrating an electronic assembly according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

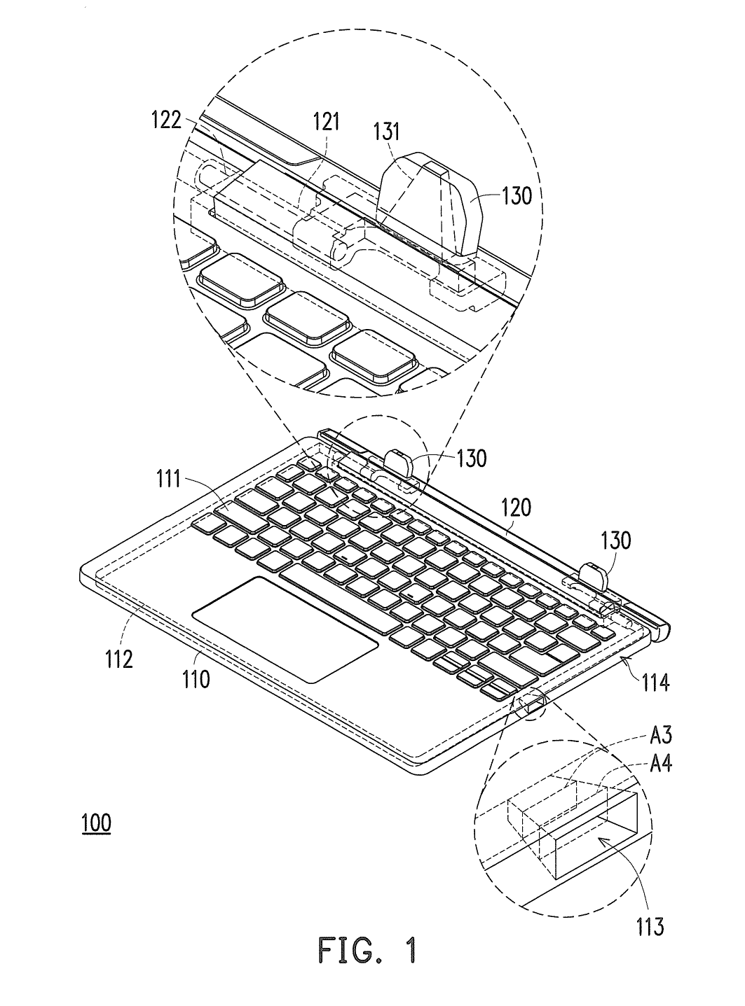

FIG. 1 is a schematic view illustrating a docking station according to an embodiment of the invention. Referring to FIG. 1, in the present embodiment, a docking station 100 includes a body 110, a supporting base 120, at least one hook 130 (two hooks 130 are exemplarily shown in FIG. 1), wherein the body 110 may have a user interface 111, for example a keyboard. On the other hand, the body 110 also has a first chamber 112 and at least one first air flow opening 113 communicated with the chamber 112. Although FIG. 1 only exemplarily depicts one first air flow opening 113 on the side wall 114 of the body 110, however it should not be construed as a limitation to the invention. In other embodiments, the first air flow opening 113 also may be disposed on a base or a surface of the user interface 111 of the body, wherein the number of first air flow opening 113 may be further adjusted according to actual needs.

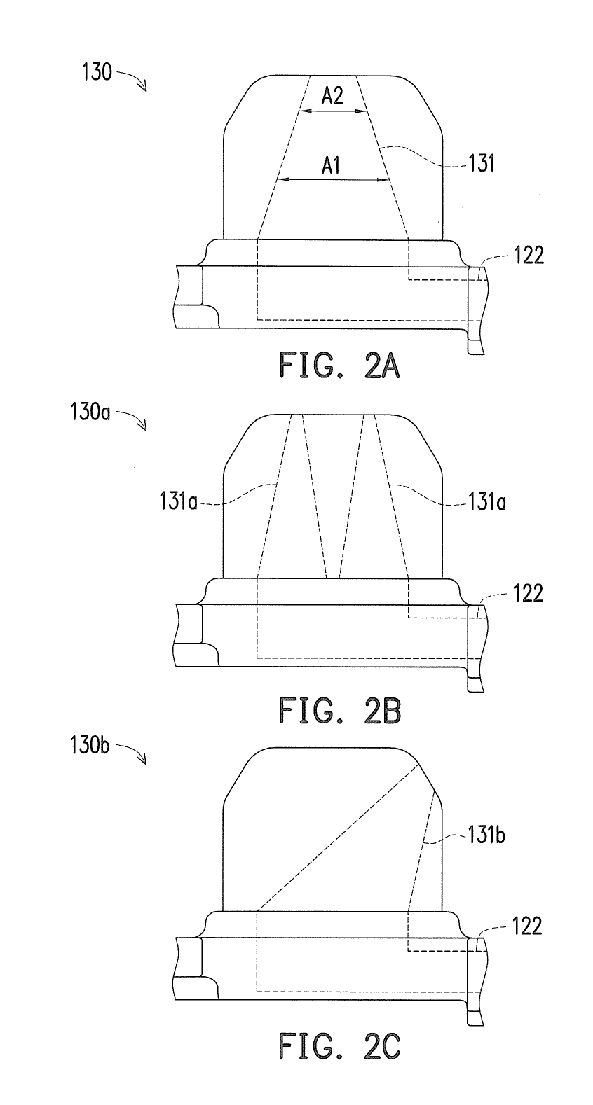

The supporting base 120 for example is pivoted to the body 110 through at least one pivoting axis 121 (two pivoting axes 121 are exemplarily shown in FIG. 1), so as to rotates relative to the body 110. Here, the supporting base 120 has at least one air flow channel 122 (two air flow channels are exemplarily shown in FIG. 2), wherein each of the air flow channels 122 may penetrates through the corresponding pivoting axis 121 and communicates with the first chamber 112. On the other hand the hook 130 protrudes from the supporting base 120, wherein each of the hooks 130 may have at least one communicating hole 131, and each of the communicating hole 131 may communicate to the first chamber 112 through the corresponding air flow channel 122. In other words, the first chamber 112 may communicate to the surrounding through the communicating hole 131 and the air flow channel 122, or communicate to the surrounding through the first air flow opening 113. Although FIG. 1 only exemplarily depicts one communicating hole 131 on each of the hooks 130, however it should not be construed as a limitation to the invention. In other embodiments, the number of communicating holes 131 on each of the hooks 130 is adjusted based on actual needs.

FIG. 2A is a partially enlarged schematic view illustrating a supporting base and a hook of FIG. 1. Referring to FIG. 1 and FIG. 2A, in the present embodiment, the respective cross-sectional area A1 of the communicating hole 131 closer to the supporting base 120 is larger than the respective cross-sectional area A2 of the communicating hole 131 further from the supporting base 120, namely that is, the hole diameter of the communicating hole 131 for example gradually expands from the surrounding to the supporting base 120. Under this design, air from the surrounding may be effectively driven to flow into the first chamber 112 through the communicating hole 131 and the air flow channel 122. On the other hand, the respective cross-sectional area A3 of the first air flow opening 113 closer to the first chamber 112 is smaller than the respective cross-sectional area A4 of the first air flow opening 113 further from the first chamber 112, namely that is, the hole diameter of the first air flow opening 113 for example gradually expands from the first chamber 112 to the surrounding. Under this design, the air from the first chamber 112 may be effectively driven and emitted to the surrounding through the first air flow opening 113.

Based on the above design concept, FIG. 2B and FIG. 2C are a partially enlarged schematic view illustrating a supporting base and a hook according to another embodiment of the invention, wherein FIG. 2B shows the number of the communicating holes 131a of the hook 130a is two, however this number may be increased based on actual needs. On the other hand, the difference in the communicating hole 131b of FIG. 2C and the communicating hole 131 of FIG. 2A lies in: the opening of the communicating hole 131b communicating with the surrounding is not located on the top surface of the hook 130b, but is disposed on a side surface of the hook 130b.

Below other embodiments will be detailed for explanation. Here it should be noted, in the below embodiments the same reference numbers and a portion of the contents from the previous embodiment are used, wherein the same reference numbers are used to represent same or like parts, and description of similar technical content will be omitted. Regarding the description of the omitted portions, reference may be made to the previous embodiment, and will not be repeated in the below embodiment.

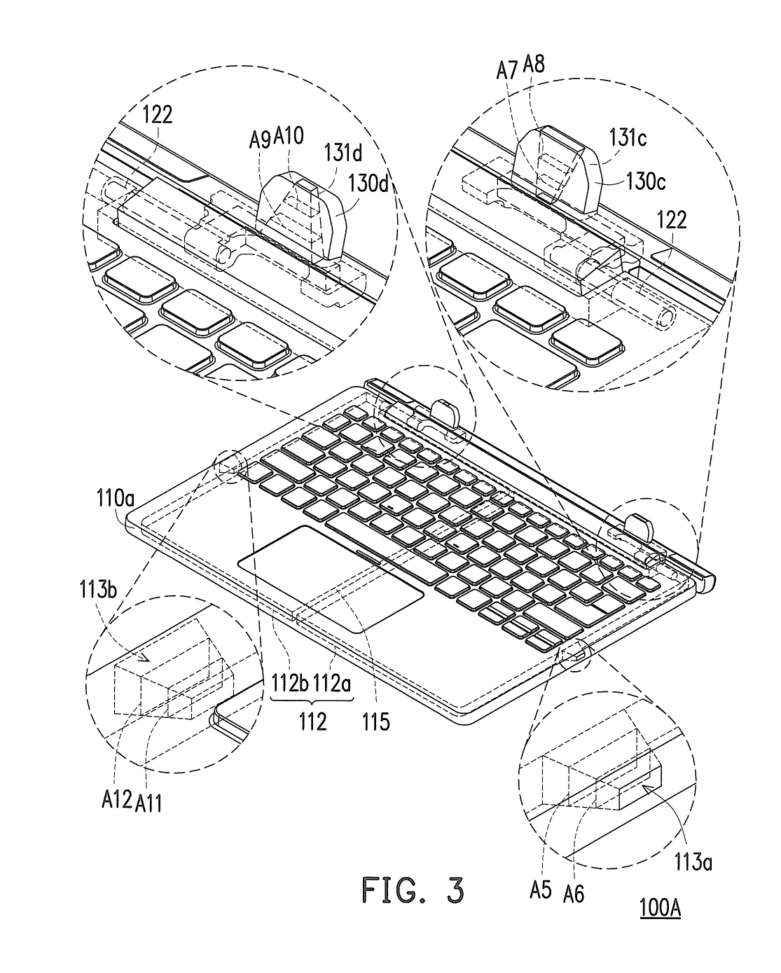

FIG. 3 is a schematic view illustrating a docking station according to another embodiment of the invention. Referring to FIG. 3 the docking station 100A of FIG. 3 and the docking station 100 of FIG. 1 are similar, where the main difference between the two lies in: a body 110a further has a blocking wall 115, used to separate the first chamber 112 into two sub chambers 112a and 112b, wherein the sub chamber 112 a and 112b are each independent and are not communicating. On the other hand, the body 110a also has a first air flow opening 113a and 113b, wherein the first air flow opening 113a and the sub chamber 112a are communicated with each other, and the first air flow opening 113b and the sub chamber 112b are communicated with each other.

Here, a respective cross-sectional area A5 of the first air flow opening 113a closer to the sub chamber 112a is larger than a respective cross-sectional area A6 of the first air flow opening 113a further from the sub chamber 112a, namely that is the hole diameter of the first air flow opening 113a for example gradually expands from the surrounding to the sub chamber 112a. On the other hand, the sub chamber 112a for example communicates with the communicating hole 131c of the hook 130c through the air flow channel 122, wherein the respective cross-sectional area A7 of the communicating hole 131c closer to the sub chamber 112a is smaller than the respective cross-sectional area A8 of the communicating hole 131c further from the sub chamber 112a, namely that is, the hole diameter of the communicating hole 131c for example gradually expands from the sub chamber 112a to the surrounding. Also, the sub chamber 112b for example communicates with the communicating hole 131d of the hook 130d through the air flow channel 122, wherein the respective cross-sectional area A9 of the communicating hole 131d closer to the sub chamber 112b is larger than the respective cross-sectional area A10 of the communicating hole 131d further from the sub chamber 112b, namely that is, the hole diameter of the communicating hole 131d for example expands from the surrounding to the sub chamber 112b. Also, the respective cross-sectional area A11 of the first air flow opening 113b closer to the sub chamber 112b is smaller than the respective cross-sectional area A12 of the first air flow opening 113b further from the sub chamber 112b, namely that is, the hole diameter of the first air flow opening 113b for example gradually expands from the sub chamber 112b to the surrounding.

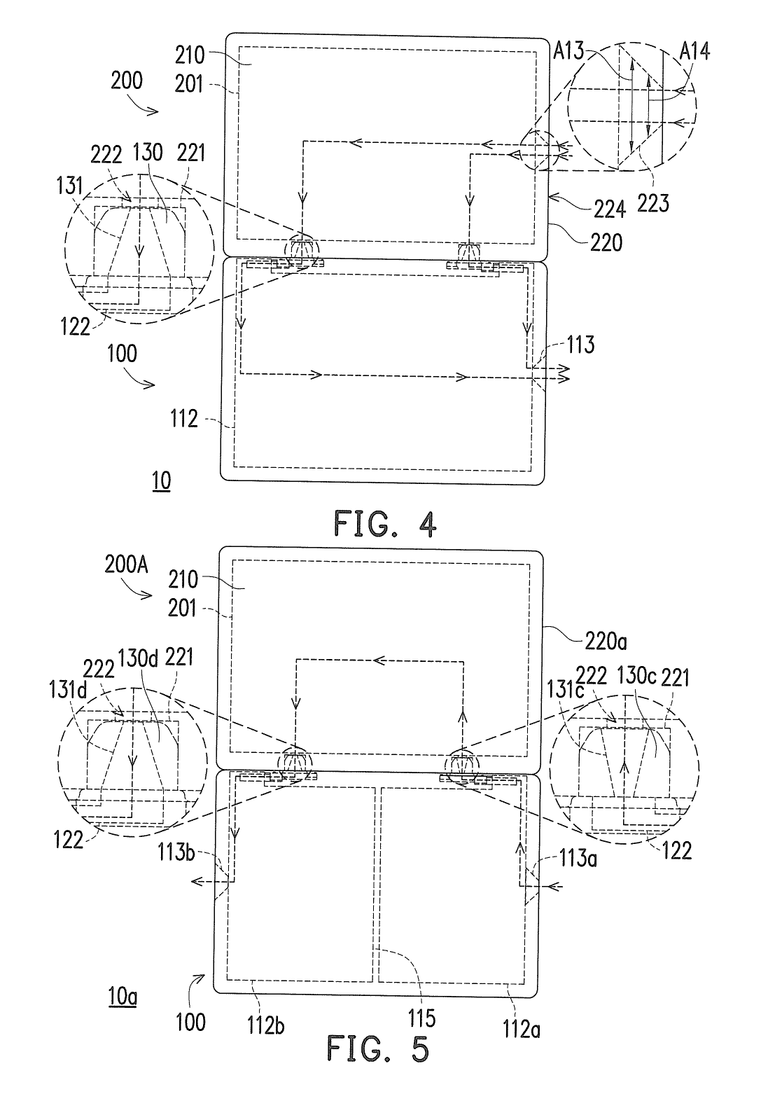

FIG. 4 is a schematic plan view illustrating an electronic assembly according to an embodiment of the invention, wherein in order for clearness of the description, partial components on the body have been omitted in FIG. 4, for example the user interface 111. On the other hand, the portable electronic device 200 for example is assembled to the docking station 100 of FIG. 1, therefore for technical content relating to the docking station 100, reference may be made to previous embodiments, and will not be repeated in the below embodiments. Referring to FIG. 4, in the present embodiment, the portable electronic device 200 is detachably assembled to the docking station 100 to make up the electronic assembly 10, wherein the portable electronic device 200 for example is a tablet PC. More specifically, the portable electronic device 200 may include a machine body 210 and a casing 220, wherein the casing 220 is engaged to the machine body 210 to define a second chamber 201.

Here, the casing 220 has at least one slot 221 (two slots 221 are exemplarily shown in FIG. 4 depicts two), at least one opening 222 located in each of the slots 221 and at least one second air flow opening 223. Although FIG. 4 only exemplarily depicts one second air flow opening 223 on the side wall 224 of the casing 220, however it should not be construed as a limitation to the invention. In other embodiments, the second air flow opening 223 may also be disposed on the base of the casing 220 or other suitable locations, wherein the number of the second air flow openings 223 may be adjusted according to actual needs. On the other hand, although FIG. 4 only exemplarily depicts one opening 222 located in each of the slots 221, however it should not be construed as a limitation to the invention. In other embodiments, the number of the opening 222 in each of the slots 221 may be adjusted according to actual needs.

The second chamber 201 respectively communicates with the second air flow opening 223 and each opening 222, and when the portable electronic device 200 is assembled to the docking station 100 and inserting each of the hooks 130 into the corresponding slot 221, the second chamber 201 communicates to the first chamber 112 through the opening 222, the communicating holes 131 and the air flow channel 122. More specifically, the respective cross-sectional area A13 of the second air flow opening 223 closer to the second chamber 201 is larger than the respective cross-sectional area A14 of the second air flow opening 223 farther from the second chamber 201, namely that is, the hole diameter of the second air flow opening 223 for example gradually expands from the surrounding to the second chamber 201.

During the operation of the portable electronic device 200, the heat produced by the internal components (not shown) increases the air temperature inside the second chamber 201. Then, the heated air in the second chamber 201 may flow into the first chamber 112 through the opening 222, the communicating hole 131 and the air flow channel 122, and then be emitted to surrounding from the first air flow opening 113. And at the same time, the cool air from the surrounding will flow in the second chamber 201 from the second air flow opening 223, to execute heat exchange with the internal components (not shown). Similarly, after the above cool air executes heat exchange with the internal components (not shown) and turns into heated air, the above heated air will flow into the first chamber 112 through the opening 222, the communicating hole 131 and the air flow channel 122, and is again emitted to the surrounding from the first air flow opening 113. Therefore, the heat produced by the internal components (not shown) may be quickly effused to the surrounding effectively, further increasing the working efficiency of the portable electronic device 200, and extending the operating life.

FIG. 5 is a schematic plan view illustrating an electronic assembly according to another embodiment of the invention, wherein in order for clearness of the description, partial components on the body have been omitted in FIG. 5, for example the user interface 111. On the other hand, a portable electronic device 200A for example is assembled to the docking station 100A of FIG. 3 to make up an electronic assembly 10A, therefore for technical content relating to the docking station 100A, reference may be made to previous embodiments, and will not be repeated in the below embodiments. Referring to FIG. 5, a casing 220a of the portable electronic device 200A may not have the second air flow opening 223. During operation of the portable electronic device 200A, the heat produced by the internal components (not shown) will increase the air temperature in the second chamber 201. Then, the heated air in the second chamber 201 may flow into the sub chamber 112b through the opening 222, the communicating hole 131d and the air flow channel 122 communicating with the sub chamber 112b, and then emitted to the surrounding from the first air flow opening 113b. And at the same time, cool air of the surrounding will flow into the sub chamber 112a from the first air flow opening 113a, and then flow into the second chamber 201 through the air flow channel 122, the communicating hole 131c and the opening 222 communicating with the sub chamber 112a, to execute heat exchange with the internal components (not shown). Similarly, after the above cool air executes heat exchange with the internal components (not shown) and turns into heated air, the above heated air will flow into the sub chamber 112b through the opening 222, the communicating hole 131d and the air flow channel 122 communicating with the sub chamber 112b, and then emitted to the surrounding from the first air flow opening 113b. Therefore, the heat produced by the internal components (not shown) may be quickly effused to the surrounding effectively by the air circulation model above, further increasing the working efficiency of the portable electronic device 200A, and extending the operating life.

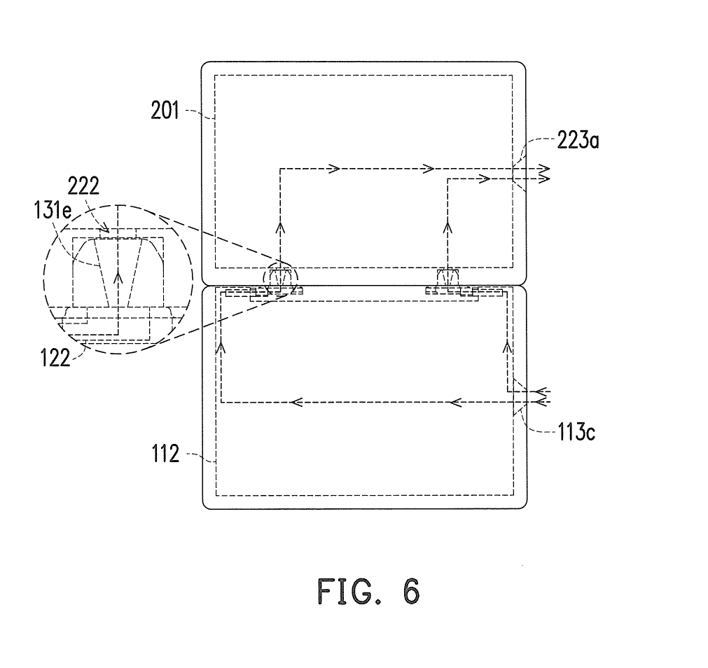

FIG. 6 is a schematic plan view illustrating an electronic assembly according to another embodiment of the invention, wherein in order for clearness of the description, partial components on the body have been omitted in FIG. 6, for example the user interface 111. Referring to FIG. 6, the difference with the above embodiments lies in, the hole diameter of the communicating hole 131e of the embodiment is disposed in a manner gradually expanding from the supporting base 120 to the second chamber 201, and the first air flow opening 113c is disposed in a manner gradually expanding from the surrounding to the first chamber 112. Also, the second air flow opening 223a is disposed in a manner gradually expanding from the second chamber 201 to the surrounding. Under this design, an air circulation that cool air flows into the first chamber 112 from the first air flow opening 113c, and then flows to the second chamber 201 through the air flow channel 122, the communicating hole 131e and the opening 222, and after executing heat exchange with the internal components (not shown), turns into heated air, and is emitted to the surrounding from the second air flow opening 223a will be obtained.

It should be noted, the hook of the above embodiments may be composed of metal or other material having high thermal conductivity in order to increase the cooling effect. On the other hand, in the first chamber 112 or the second chamber 201, a fan may be optionally disposed, to increase the air flow rate.

In summary, the hook of the docking station of the invention has the communicating hole communicating to the first chamber of the body through the air flow channel of the supporting base, and the first chamber communicates to the surrounding through the first air flow opening. On the other hand, the second chamber is defined by the machine body and the casing engaged with each other of the portable electronic device, wherein the casing has the opening and the second air flow opening communicating with the second chamber, and the opening is located in the slot. Therefore, the hook will be inserted into the slot after the portable electronic device is assembled to the docking station to make up the electronic assembly. Here, the first chamber may communicate with the second chamber through the air flow channel, the communicating hole and the opening.

During the operation of the portable electronic device, the heat produced by the internal components will increase the air temperature in the second chamber. Then the heated air in the second chamber may flow into the first chamber through the opening, the communicating hole and the air flow channel, and then emitted to the surrounding from the first air flow opening. And at the same time, cool air of the surrounding will flow into the second chamber from the second air flow opening, and execute heat exchange with the internal components, and similarly, after the above cool air executes heat exchange with the internal components and turns into heated air, the above heated air flows to the first chamber through the opening, the communicating hole and the air flow channel, and is then emitted to the surrounding from the first air flow opening. Therefore, the heat produced by the internal components may be quickly effused to the surrounding effectively by the above air circulation model, further increasing the working efficiency of the portable electronic device, and extending the operating life.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A docking station, suitable for a portable electronic device, the docking station comprising:
a body, having a chamber and at least one air flow opening communicating with the chamber;
a supporting base, pivoted to the body, and has at least one air flow channel; and
at least one hook, protruding from the supporting base, and has at least one communicating hole, the at least one air flow channel communicating the at least one communicating hole and the chamber.

2. The docking station as claimed in claim 1, wherein a respective cross-sectional area of the at least one communicating hole closer to the supporting base is larger than a cross-sectional area of the at least one communicating hole further from the supporting base.

3. The docking station as claimed in claim 1, wherein a respective cross-sectional area of the at least one communicating hole closer to the supporting base is smaller than a respective cross-sectional are of the at least one communicating hole further from the supporting base.

4. The docking station as claimed in claim 1, wherein a respective cross-sectional area of the at least one air flow opening closer to the chamber is smaller than a respective cross-sectional area of the at least one air flow opening further from the chamber.

5. The docking station as claimed in claim 1, wherein a respective cross-sectional area of the at least one air flow opening closer to the chamber is larger than a respective cross-sectional area of the at least one air flow opening further from the chamber.

6. The docking station as claimed in claim 1, wherein the supporting base comprises at least one pivoting axis pivoted to the body, the at least one air flow channel penetrating through the at least one pivoting axis and communicating with the chamber.

7. The docking station as claimed in claim 1, wherein a number of the at least one air flow openings is two, the body further having a blocking wall, used to separate the chamber into two sub chambers, each of the sub chambers communicating with the corresponding air flow opening.

8. An electronic assembly comprising:
a docking station, comprising:
a body, having a first chamber and at least one first air flow opening communicating with the chamber;
a supporting base, pivoted to the body, and having at least one air flow channel; and
at least one hook, protruding from the supporting base, and having at least one communicating hole, the at least one air flow channel communicating the at least one communicating hole and the first chamber; and
a portable electronic device, detachably assembled to the docking station, the portable electronic device comprising:
a machine body; and
a casing, engaged to the machine body, and defining a second chamber, wherein the casing has at least one slot, at least one opening located in the at least one slot and at least one second air flow opening, the second chamber respectively communicating the at least one second air flow opening and the at least one opening,
when the portable electronic device is assembled to the docking station inserting the at least one hooks into the at least one slots, the second chamber communicates to the first chamber through the at least one opening, the at least one communicating hole and the at least one air flow channel.

9. The electronic assembly as claimed in claim 8, wherein a respective cross-sectional area of the at least one communicating hole closer to the supporting base is larger than a respective cross-sectional area of the at least one communicating hole further from the supporting base.

10. The electronic assembly as claimed in claim 8, wherein a respective cross-sectional area of the at least one communicating hole closer to the supporting base is smaller than a respective cross-sectional area of the at least one communicating hole further from the supporting base.

11. The electronic assembly as claimed in claim 8, wherein a respective cross-sectional area of the at least one first air flow opening closer to the first chamber is smaller than a respective cross-sectional area of the at least one air flow opening further from the first chamber.

12. The electronic assembly as claimed in claim 8, wherein a respective cross-sectional area of the at least one first air flow opening closer to the first chamber is larger than a respective cross-sectional area of the at least one first air flow opening further from the first chamber.

13. The electronic assembly as claimed in claim 8, wherein the supporting base comprises at least one pivoting axis pivoted to the body, the at least one air flow channel penetrating through the at least one pivoting axis and communicating with the first chamber.

14. The electronic assembly as claimed in claim 8, wherein a number of the at least one first air flow opening is two, the body further having a blocking wall, used to separate the first chamber into two sub chambers, each of the sub chambers communicating with the corresponding first air flow opening.

15. The electronic assembly as claimed in claim 8, wherein a respective cross-sectional area of the at least one second air flow opening closer to the second chamber is larger than a respective cross-sectional area of the at least one second air flow opening further from the second chamber.
